(19) United States
(12) Patent Application Publication
(10) Pub. No.: US 2012/0299526 A1
(43) Pub. Date: Nov. 29, 2012

(54) Perpetual EV split power system

(75) Inventor: Steven R. Lambert, Gilbert, AZ (US)

(73) Assignee: Steven Rene Lambert, Gilbert, AZ (US)

(21) Appl. No.: 13/068,831

(22) Filed: May 23, 2011

(51) Int. Cl. H01M 10/46; F03D 9/00; H02K 53/00

(52) U.S. Cl. 320/101; 290/55; 74/DIG. 9

(57) ABSTRACT

The creation of the vehicle customized in any existing vehicle (cars, buses, trucks, trains, etc.) for energy efficiency perpetual pollution free transportation for worldwide use utilizing the windows power that naturally occurs while transporting forward converting it into electricity to keep a vehicle traveling a forward motion.

### FIELD OF INVENTION

This invention relates to the need of having an electric vehicle self charge as you drive eliminating CO2 and other toxic gases and no longer needing to burn fossil fuels throwing pollution in the air thus eliminating the CO2 emissions to zero. This invention would be beneficial to everyone around the world. The split system enables you to drive a vehicle with one power system and charging the battery with a secondary charging system. Global warming has gotten worse, pollution in the air is overwhelming to the environment and this vehicle puts out no negative impact on the environment therefore exists a need for this invention world wide. The creation of this inexpensive and functional drive system on this electric vehicle can convert any vehicle with affordability, longer lasting parts and less overall maintenance to the vehicle. Recycling plays a big part in this as well. It is simple to add this existing technology into today's automobile generating the ability to convert any vehicle with this affordable system that pays for itself in a very short period of time.

### DESCRIPTION OF PRIOR ART

There are other electric vehicles designed for regenerating electricity. Such as Haberer U.S. Pat. No. 4,075,545, Biggs U.S. Pat. No. 4,094,377. Sparks U.S. Pat. No. 4,132,282, Treat U.S. Pat. No. 4,141,425. Travis U.S. Pat. No. 4,270,622 Medina U.S. Pat. No. 4,578,955 Gardiner U.S. Pat. No. 4,825,656 Stulbach U.S. Pat. No. 5,215,156 Taylor U.S. Pat. No. 5,280,827 Brighton U.S. Pat. No. 5,746,283. Limonius No. 2002/0153178 A1 yet all of these claims have been either abandoned or not viable do to design with then fall under 35 U.S.C. 102 and should not apply. To date my prototype is the only one that I have found that works. I find that number Wedderburn No. 2009/0301796 A1 Air Electric Vehicle to be a very interesting concept. However the power requirements FIG. 6 is insufficient for proper speed for standard driving. The top speed looks to be 36 mi/h witch is ineffective to drive on the highways. FIG. 5 Shows belts and gears witch would create high friction and would not be able to maintain the rotation of the blade.

Other past artists have utilized alternators for their needs power needs for electric cars. This does not supply enough power.

When looking at the art of adding air to generate electricity you equally so need to take into consideration the propulsion of the motor and its requirements in the past other artists had negated this particular information which is most likely why they have not created it. I started out with this thought in mind and started my entire power requirements with the requirements needed to propel the vehicle forward have a straight streamlined design and still utilize the air to propel the vehicle forward, By creating a vehicle that's functionally work unlike the other artist. In the past many artists had a good idea and did not follow through. This is a functional vehicle.

### SUMMARY OF THE INVENTION

It is the general objective of this present invention to provide energy efficient transportation reducing pollutions with affordability. By having to systems in the any vehicle, running one system for the main drive by utilizing airflow for long distance and another system to charge the battery for around town and getting up to the necessary speed to perpetually go for a unlimited distance.

### BRIEF DESCRIPTION OF DRAWINGS

Objects and features which makes this present invention work are set for in the following figures graphs and schematics

FIG. 1 Shows front elevation of the existing prototype.

FIG. 2 Shows side elevation of existing prototype

FIG. 3 Shows bottom perspective view of existing prototype.

FIG. 4 Shows side elevation of fan duct generator cross-section.

FIG. 5 Shows the schismatic of the split system and drive-train assembly.

FIG. 6 Shows graphs power graphs of speed volt ratio put out.

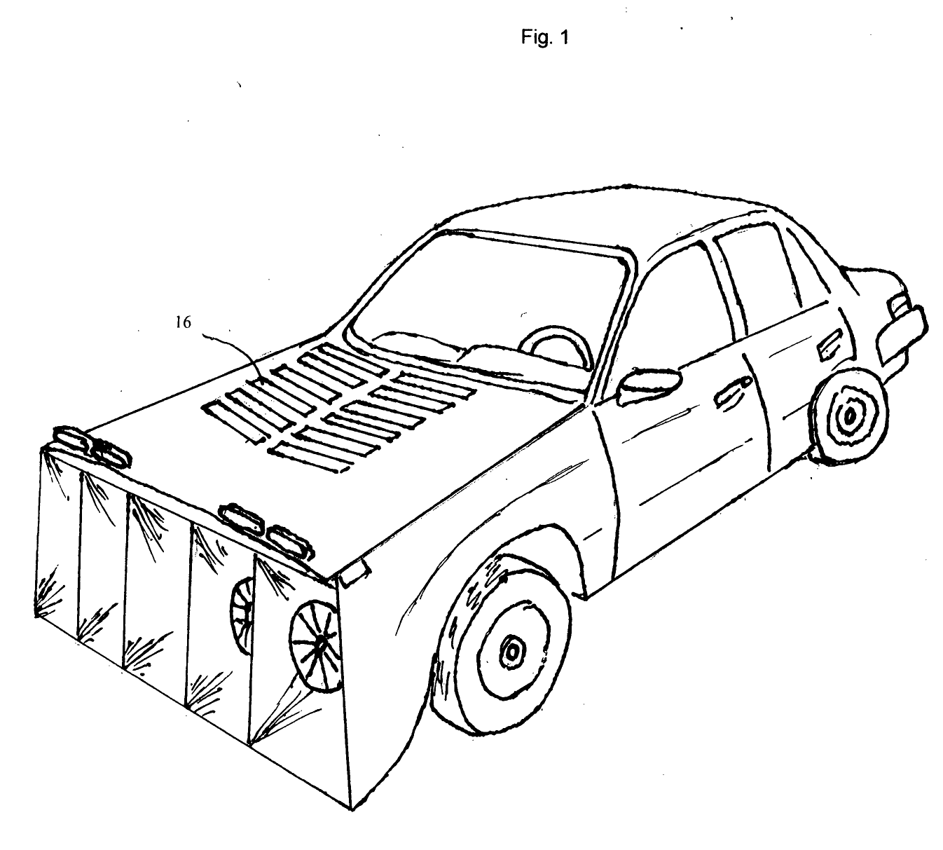

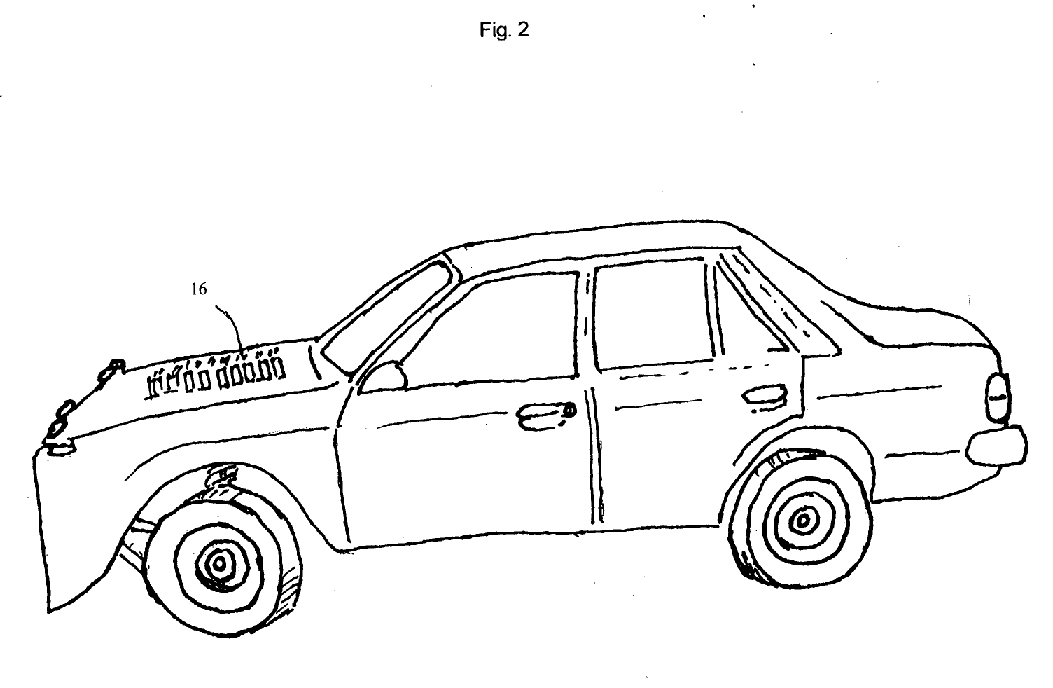

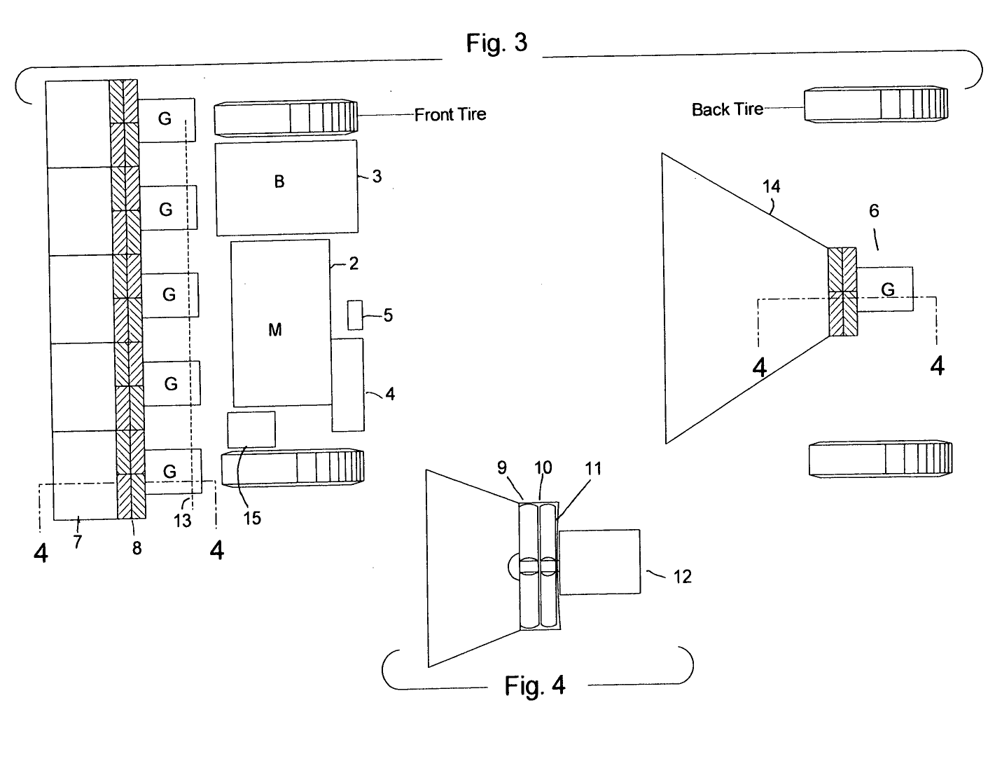

### DESCRIPTION OF THE PREFERRED EMBODIMENT

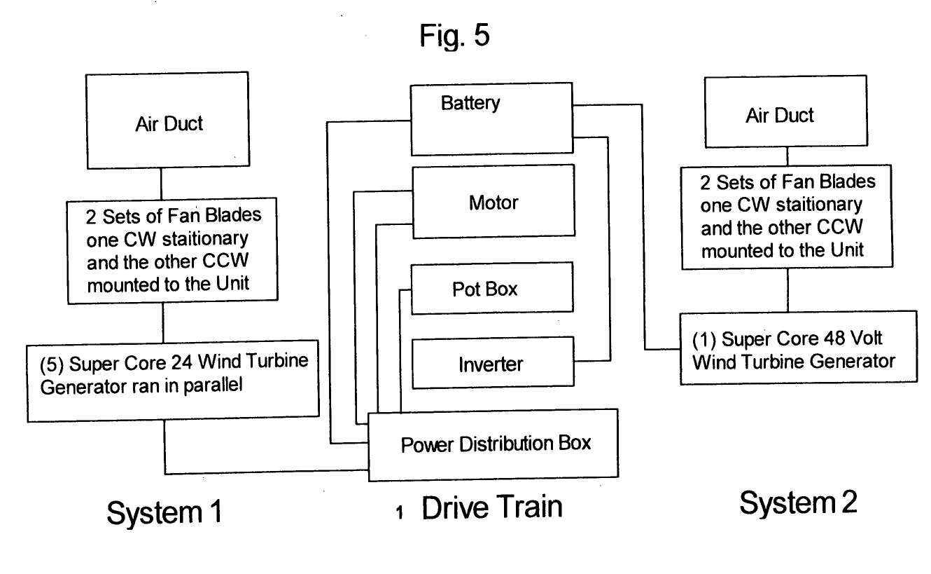

Utilizing a typical electric vehicle drive-train. FIG. 5 1 propelling vehicle forward with the motor 2 powered by a battery 3 connected to the 4 power distribution box controlled by a 5 pot box that governs the speed of the vehicle. When the vehicle is propelled forward the rear charging system 6 replenish power to the battery. Air flows into the 7 duct work at the front of the vehicle being forced past two sets of 8 fan blades mounted in opposite directions the first blade 9 mounted stationary in the 10 housing of the duct work. The FIG. 4 air duct system has one stationary angled fan blade in a clockwise position located in front of 11 the other angled fan blade in a counter clock wise position mounted to the 12 Super Core twenty four Wind Turbine Generator. (SC 24) This SC 24 is magnetically charge through the entire core of the unit for high efficiency and high power output. five of these 12 SC 24's are ran in parallel connecting to the 4 power distribution box.

When five of these 12 SC 24's are ran in parallel 13 and the power is connected to the 5 power distribution box then there is enough Volts and amps to propel the car forward in continuous motion. With this continuous motion air flows into the 14 back air duck passing through the FIG. 4 fan blades rotating the 12 generator which has a Super Core 48 Wind Turbine Generator witch recharges the 3 48 Volt battery that initiated the propulsion of the prototype vehicle. A power inverter 15 which takes the 48 Volts and converts 12 Volts sending it throughout the existing system thus by creating easy adaptability to any vehicle. (cars, buses, trucks, trains, etc.)

FIG. 5 schematics shows more easily how all these components come together and interact in any vehicle.

Elevations 1 and 2 air flow release vents 16 were placed in the hood to allow air to flow through more easily thus balancing out the intake to outtake flow of air.

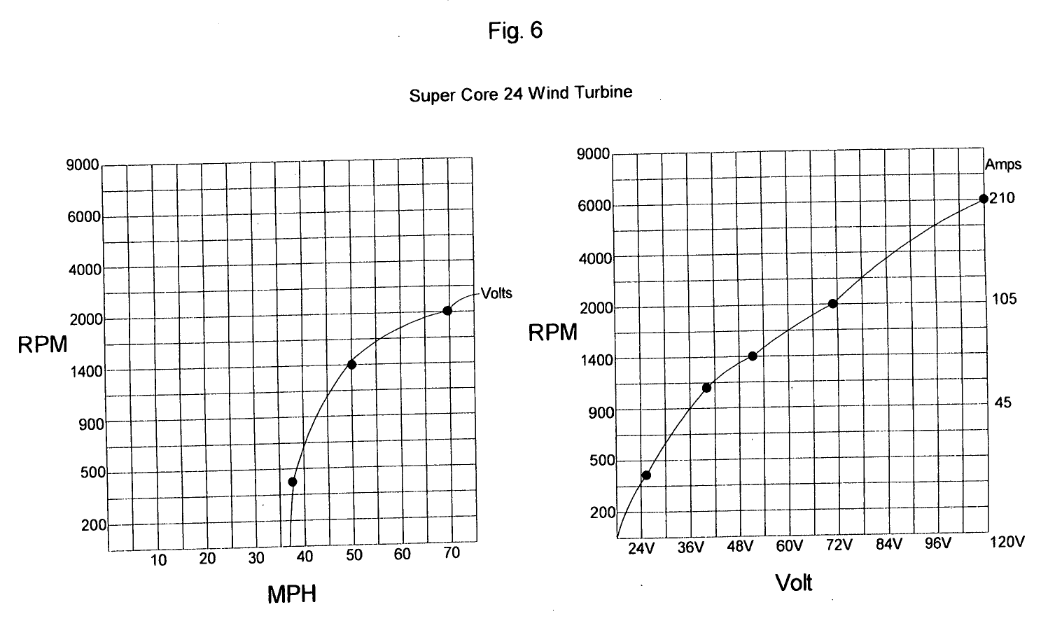

FIG. 6 Shows one SC 24 Wind Turbine Generator RPM's for power output and with mi./h and volts generated with amps power graphs.

At 35 to 40 mi./h the existing prototype vehicle blades start rotating thus giving me RPM's generated in return give me power for my drive-train assembly maintaining forward momentum.

FIGS. 6 graph shows you at approximately 50 mi./h you get approximately 1400 RPMs which then in return will give me about 50 Volts and about 75 amps. With five SC 24's ran in parallel then gives me a total of 50 Volts and 350 amps witch then runs into the power distribution box for 2 motor and will keep the vehicle running with forward momentum.

As you can see by this power graph chart FIG. 6 the faster you go the more power you generate to then propel the vehicle even faster and or operate other accessories in the vehicle.

The Wind Turbine Generator I have chosen supply enough Volts and Amps combined to move the vehicle properly. At ˜30 Volts it generates ˜45 Amps combined is ˜225 Amps. At ˜50 Volts it generates ˜75 Amps combined is 350 Amps which is plenty of power to move the vehicle at ˜70 Volts they generate approximately ˜105 Volts combined is ˜525 Amps. At ˜120 Volts they generate approximately ˜210 Amps for a total of ˜1050 Volts which will take you well beyond the posted speed limit.

What is claimed is:

1. Having one or more Wind Turbine Generators direct powering 1 or more electric motor(s) for momentum in a vehicle.

2. Utilizing one or more fan blades to turn the said Wind Turbine Generator for powering and/or recharging of a vehicle.

3. Utilizing duct work to turn fan blades to turn the Wind Turbine Generator to supply power to the motor(s).

4. Utilizing reverse air fins blade located stationary in the duct work to guide air fluidly to flow into a opposite facing fan blades for a Wind Turbine Generator.

5. with a second same like system set forth in claim 4 that charges a battery that powers a transportation vehicle.
